(19) United States
(12) Patent Application Publication
(10) Pub. No.: US 2016/0263641 A1
(43) Pub. Date: Sep. 15, 2016

(54) WORK STATION AND METHOD FOR JOINING METALLIC SHEETS

(71) Applicant: UTICA ENTERPRISES, INC., Troy, MI (US)

(72) Inventors: Mark A. SAVOY, Warren, MI (US); Phillip J. I. MORGAN, Royal Oak, MI (US)

(21) Appl. No.: 15/066,388

(22) Filed: Mar. 10, 2016

Related U.S. Application Data
(60) Provisional application No. 62/132,730, filed on Mar. 13, 2015.

(51) Int. Cl. B21D 39/03; B62D 65/02

(52) U.S. Cl. CPC B21D 39/031; B21D 39/034; B62D 65/024

(57) ABSTRACT

A work station (10) and method for joining metallic sheets (12, 14) by a framework (24) that supports and positions a parallel kinematic machine (PKM) (40) including a tripod (46) having struts (48) of adjustable lengths for supporting a punch (52) that cooperates with an anvil (22) to provide clenching or self-piercing riveting that joins the metallic sheets.

### CROSS-REFERENCE TO RELATED APPLICATIONS

This application claims the benefit of U.S. provisional application Ser. No. 62/132,730 filed Mar. 13, 2015, the entire disclosure of which is hereby incorporated by reference.

### TECHNICAL FIELD

This invention relates to a work station and a method for joining metallic sheets and has particularly utility for vehicle body joining of metallic sheets where a relatively large metallic sheet is joined to another metallic sheet.

### BACKGROUND

When a relatively large metallic sheet is joined to another metallic sheet, such as during vehicle body fabrication, there can be relatively large distances that make the joining by metal deformation difficult because a punch and anvil mounted conventionally on a C-shaped frame cannot easily extend inwardly from the outer edges of the largest sheet to a more central location nor can the angular positioning involved be easily accommodated for different forming orientations of the vehicle body. A fixed anvil located below the metallic sheets to be joined and a punch mounted on the arm of a conventional robot cannot operate with the force normally necessary to provide the sheet metal deformation for the joining.

### SUMMARY

One object of the present invention is to provide an improved work station for joining metallic sheets.

In carrying out the above object, the work station for joining metallic sheets according to the invention includes a floor that has a mount for supporting an anvil and extends along a longitudinal X axis and a lateral Y axis perpendicular to the X axis. A framework of the work station includes posts extending upwardly along a vertical Z axis from the floor in a perpendicular relationship to the X and Y axes, and the framework includes beams that extending between the posts along both the X and Y axes spaced upwardly from the floor to define a workspace. A shuttle of the work station is suspended on the framework for movement along one of the X and Y axes above the workspace. A parallel kinematic machine (PKM) of the work station includes an upper support suspended from the shuttle for movement along the other of the X and Y axes, and a tripod of the PKM has three struts mounted on the upper support and extending downwardly in a converging manner toward each other. A lower support of the PKM is mounted by the three struts below the upper support to mount a punch operable to cooperate with the anvil to provide sheet metal deformation that joins two metallic sheets to each other. The three struts of the PKM tripod each have an upper end connected to the upper support of the PKM and a lower end pivotally connected to the lower support, and each strut has an adjustable length between its upper and lower ends. A controller of the work station: positions the shuttle on the framework along said one axis; positions the PKM on the shuttle along said other axis; individually adjusts the length of each strut to position the lower support along the Z axis and control its angular orientation to position the punch angularly; and operates the punch to cooperate with the anvil to provide sheet metal deformation that joins two metallic sheets to each other.

As disclosed, a roller screw of each strut has an elongated screw and a nut including a plant carrier and a plurality of threaded rollers rotatably on the planet carrier and meshed with the screw such that relative rotation between the screw and nut adjusts the length of the strut. Also, the PKM disclosed includes first and second universal joint assemblies on the upper support, with the first universal joint assembly pivotally mounting the upper end of one of the struts on the upper support for pivoting about a first horizontal axis and about another axis perpendicular to the first horizontal axis, and with the second universal joint assembly pivotally mounting the upper ends of the other two struts on the upper support for pivoting about a second horizontal axis that is parallel to the first horizontal axis of the first universal joint assembly and respectively also pivotally mounting the upper ends of the other two struts about a pair of parallel axes that are each perpendicular to the second horizontal axis.

The disclosed PKM also has a first pivotal connection that pivotally connects the lower end of the first strut to the lower support about an axis that is parallel to the first and second horizontal axes, and also includes a pair of second pivotal connections that respectively pivotally connect the lower ends of the other two struts to the lower support about a pair of axes that are parallel to each other and perpendicular to the axis of the first pivotal connection.

The work station disclosed has the lower support including a punch mounting bracket rotatable 360 degrees on the lower support and operable to support the punch for angular adjustment, and an electric motor rotates the punch mounting bracket on the lower support and another electric motor angularly positions the punch on the mounting bracket.

The work station disclosed is a vehicle body work station of a sufficiently large size for receiving vehicle body components embodying the metallic sheets.

Another object of the present invention is to provide an improved method for joining metallic sheets using the work station described above to provide a clinching operation or a self-piercing riveting operation that connects the metallic sheets.

### BRIEF DESCRIPTION OF THE DRAWINGS

FIG. 1 is a cross-sectional view of a work station constructed in accordance with the present invention to perform the method thereof which has particular utility as a vehicle body work station for joining vehicle body sheet metal components.

FIG. 2 is a side view of the work station taken along the direction of line 2-2 in FIG. 1.

FIG. 3 is a perspective view of a parallel kinematic machine (PKM) that is suspended from a framework of the work station to support a punch used with a lower fixed anvil to provide sheet metal deformation for joining two or more metallic sheets to each other.

FIG. 4 is a further view of the PKM illustrating its construction.

FIG. 5 is a partially broken away perspective view of a roller screw of each of three struts of a tripod of the PKM that has sufficient strength to provide the metal deformation for joining the metallic sheets.

FIG. 6 is a sectional view illustrating the manner in which the work station can provide clenching of two metallic sheets for joining them to each other.

FIG. 7 is a sectional view that illustrates the manner in which the work station can operate to provide self-piercing riveting of two metallic sheets to be joined.

FIG. 8 is a view illustrating an anvil mount, an anvil, and a PKM mounted punch that collectively perform the metallic sheet joining.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

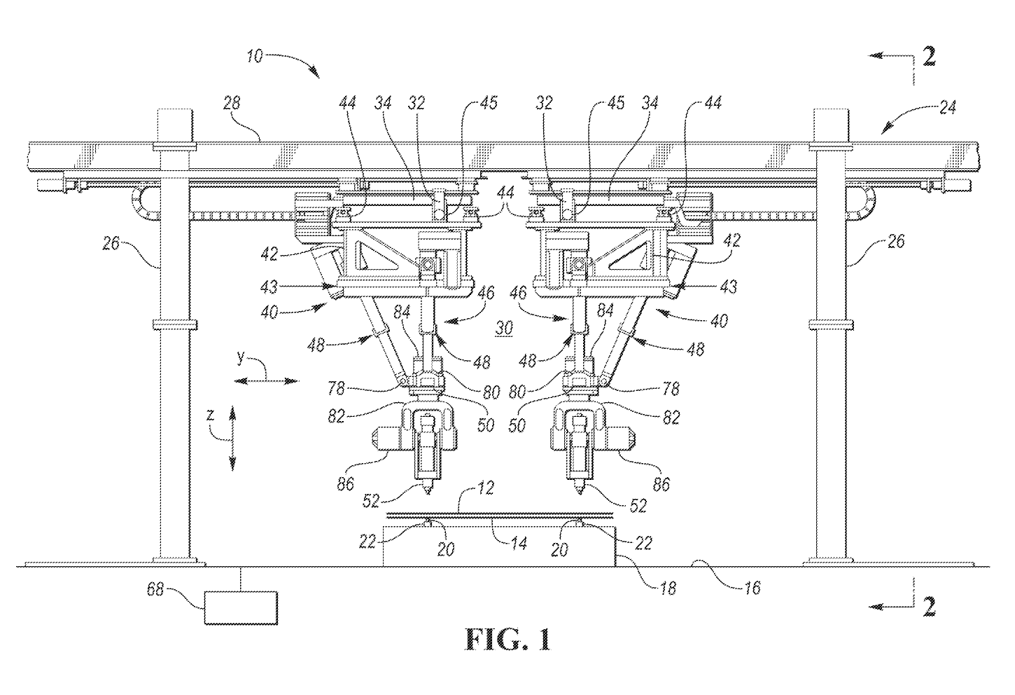

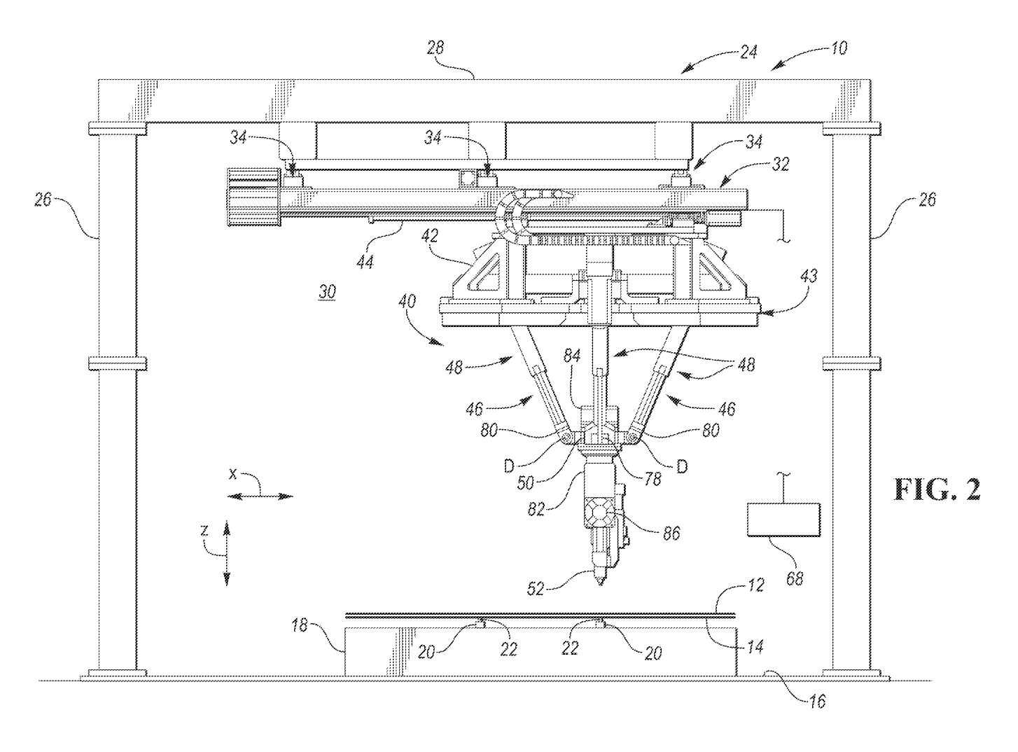

As illustrated in FIGS. 1 and 2, a work station embodying the present invention is generally indicated by 10 and performs a method of the invention to join metallic sheets 12 and 14. The work station as disclosed is a vehicle body work station for joining vehicle body sheet metal components such as a vehicle body underbody floor and other underbody components. Both the work station and the method of joining the metallic sheets will be described in an integrated manner to facilitate an understanding of different aspects of the invention.

With continuing reference to FIGS. 1 and 2, the work station includes a floor 16 having floor platform 18 having a mount 20 for supporting an anvil 22 used in the sheet metal joining. The floor extends along a longitudinal X axis as shown by the arrows in FIG. 2 and along a lateral Y axis that is perpendicular to the X axis and shown by the arrows Y in FIG. 1. A framework of the work station is generally indicated by 24 and includes posts 26 extending upwardly along a vertical Z axis from the floor 16 in a perpendicular relationship to the longitudinal X axis and the lateral Y axis as shown in FIGS. 1 and 2. The framework 24 also includes beams 28 that extend between the posts 26 at their upper ends along both the X and Y axes spaced upwardly from the floor 16 to define a work space 30. A shuttle 32 shown in FIGS. 1 and 2 is suspended on the framework 24 by suspension tracks 34 for movement along the Y axis as disclosed.

As shown in FIGS. 1-3, the work station includes at least one parallel kinematic machine (PKM) 40, actually two side by side PKMs as shown in FIG. 1, each of which includes a riser 42 that mounts an upper support 43 of the PKM and that is suspended on the shuttle 32 by suspension tracks 44 for movement along the X axis. The support of each PKM 40 thus allows movement to any required X, Y location. Also, it should be appreciated that the movement of the shuttle 32 can also be in the X direction with the movement of the PKM on the shuttle in the Y direction while still providing positioning at any X, Y location at which the metal joining needs to be performed. The movement of the shuttle 32 on the framework 24 and the movement of the PKM 40 on the shuttle 32 are controlled by electric motors 45 that are powered and controlled by respective cables and wires.

As best illustrated in FIGS. 2, 3 and 4, each PKM 40 includes a tripod 46 having three struts 48 mounted on the upper support 43 and extending downwardly in a converging manner toward each other. A lower support 50 of the tripod 46 is mounted by the three struts 48 below the upper support 43 to mount a punch 52 operable to cooperate with the anvil 22 as shown in FIG. 1 to provide sheet metal deformation that joins the two metallic sheets 12 and 14 to each other.

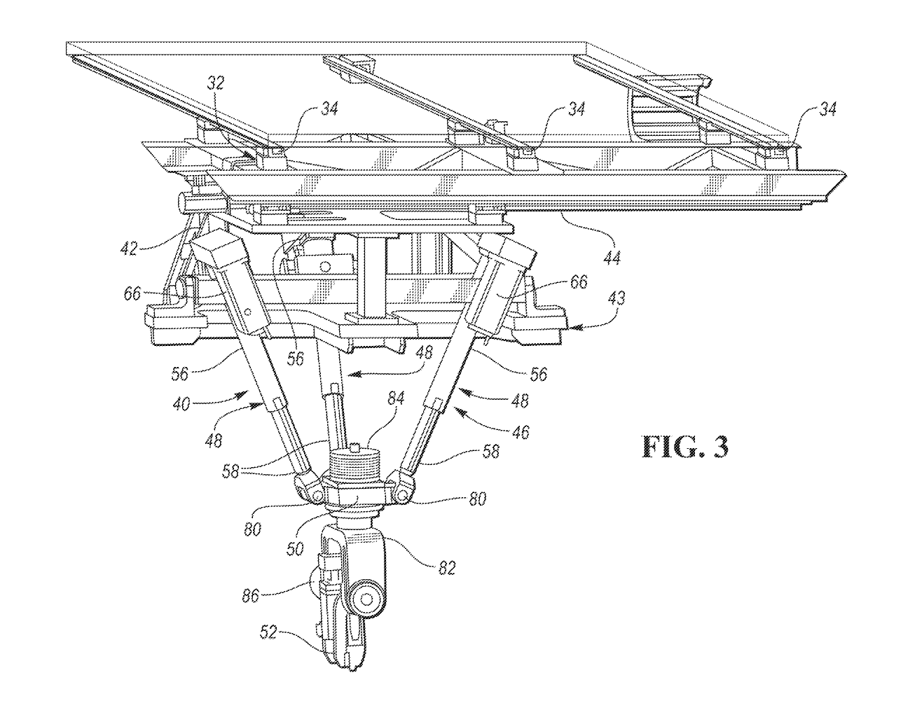

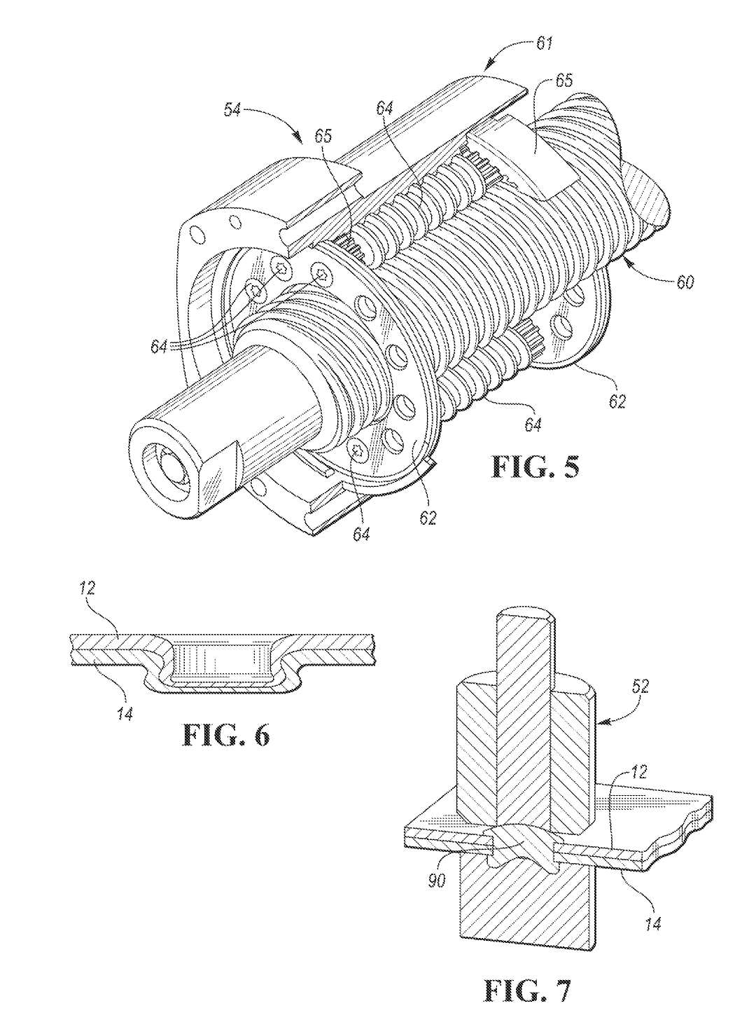

The three struts 48 of the PKM tripod 46 as shown in FIG. 3 each have an upper end 56 connected to the upper support 43 of the PKM and a lower end 58 pivotally connected to the lower support 50. Each strut 48 as disclosed has a roller screw 54 shown in FIG. 5 as including an elongated screw 60 and a nut 61 that receives the screw and includes a planet carrier 62 and a plurality of threaded rollers 64 meshed with the screw 60 and having gear ends meshed with rings 65 that are supported by the nut 61 for rotation with respect thereto about the central axis of the screw 60. Each strut 48 as is hereinafter more fully described has an electric motor 66 located adjacent its upper end 54 and rotatively connected to screw 60 to rotate the screw to provide relative rotation between the screw and the nut which adjusts the axial length of the strut 48. The change in strut length allows the lower support 50 to be moved vertically along the Z axis. The length of one strut 48 with respect to the other two struts or the length of each of the three struts with respect to each other strut adjusts the inclination of the lower support 50 to provide the proper angularity of the punch for performing the metallic deformation joining operation.

Each roller screw 54 is constructed as described above and as disclosed by U.S. Pat. No. 7,044,017, the entire disclosure of which is hereby incorporated by reference. More specifically, the roller screw construction provides “helical line contact” as opposed to “point contact” provided by ball screws and thus can operate with greater force in providing the joining of metallic sheets than can ball screws of the same size. The lengths of the struts can also be adjusted by ball screws or by linear drives that are electrically driven, etc.

With reference to FIGS. 1 and 2, a controller 68 controls the operation of all of the components of the work station. Specifically, the controller positions the shuttle 32 on the framework 24 and positions the PKM 40 on the shuttle so that the X, Y positioning of the joining can be controlled. In addition, the controller 68 individually operates the roller screws 54 of the struts 48 to control the lengths of the struts and position the lower support along the Z axis and control its rotational position and inclination, as is more fully described later, to position the punch as required. Furthermore, the controller 68 operates the punch 52 to cooperate with the anvil 22 to join the two metallic sheets to each other.

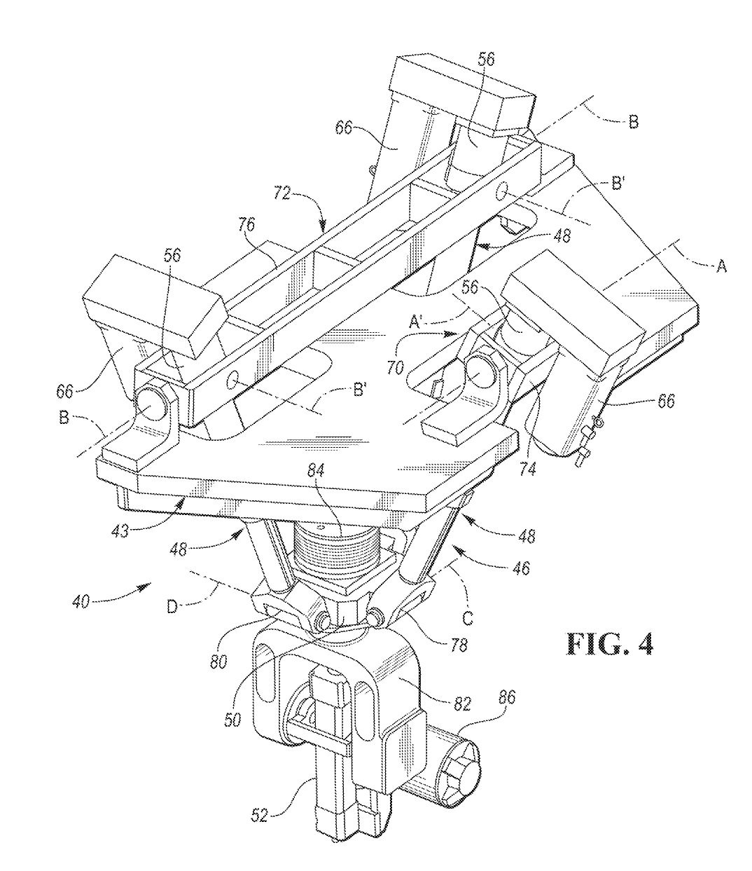

As illustrated in FIG. 4, the PKM 40 includes first and second universal joint assemblies 70 and 72. The first universal joint assembly 70 includes a generally square support frame 74 that receives the upper end 56 of a first strut 48 and is pivotal about a first horizontal axis A so as to pivotally support the associated strut about that axis. A hidden trunnion type pivotal support of the frame 74 pivotally mounts the upper end of the first strut 48 about another axis A′ that is perpendicular to the first axis A so as to permit further pivotal movement of the first strut. The second universal joint assembly 72 includes a rectangular support frame 76 having opposite ends that respectively receive the upper ends 56 of the other two struts 48 to provide pivotal support thereof on the upper support 43 about a second horizontal axis B that is parallel to the first horizontal axis A. The support frame 76 also has hidden trunnion type supports that pivotally mount the upper end 56 of the two associated struts 48 for pivoting about a pair of parallel axes B′ that are each perpendicular to the second horizontal axis B. The two struts 48 mounted by the support frame 76 are thus pivotal in a common plane about their associated axes B′ and that plane is pivotal about the second horizontal axis B.

With continuing reference to FIG. 4, the PKM 40 also includes a first pivotal connection 78 that pivotally connects the strut 48 at its lower end to the lower support 50 of the PKM about an axis C that is parallel to the first and second horizontal axes A and B. The PKM 40 also includes a pair of second pivotal connections 80 that respectively pivotally connect the lower ends 58 of the two struts 48 mounted by the support frame 76 to the lower support 50 about a pair of axes D (FIG. 2) that are parallel to each other and perpendicular to the axis C of the first pivotal connection 78.

As best shown in FIGS. 2-4, the lower support 50 of the PKM 40 includes a punch mounting bracket 82 that is rotatable 360° on the lower support and operable to support the punch 52 for rotational adjustment by a rotary actuator embodied by an electric motor 84, and another electric motor 86 angularly positions the punch 52 on the mounting bracket 82 to the required angular position for the metallic deformation that performs the metallic sheet joining.

As illustrated in FIG. 6, the work station can join the metallic sheets 12 and 14 by a clinching operation. Also, as illustrated in FIG. 7, the metallic sheets 12 and 14 can also be joined by a self-piercing riveting operation with a rivet 90. It is also possible to join a third metallic sheet or more to the two metallic sheets shown. Furthermore, a smaller vehicle body component with a flat sheet shaped connection portion can be joined to a larger metallic sheet at an inward location from its edge extremity where a conventional C-shaped support cannot be used.

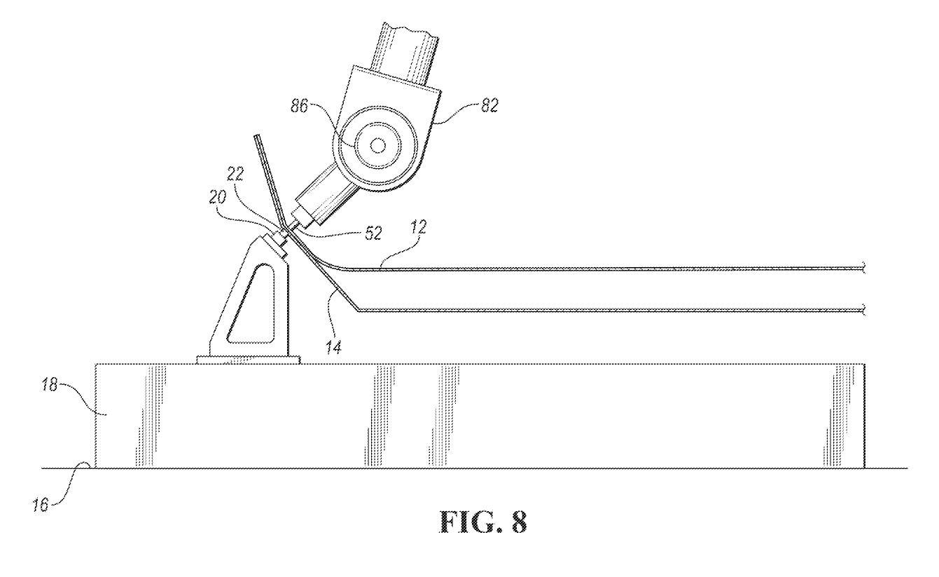

FIG. 8 is a view that shows the punch mounting bracket 82 mounting the punch 52 that cooperates with the anvil 22 on the anvil mount 20 to provide joining of the metallic sheets 12 and 14.

The struts 48 have adjustable lengths controlled by operation of the roller screw 54. More specifically, the electric motor 66 rotatively drives the screw 60 by an endless chain. The roller screw nut 61 shown in FIG. 5 is connected to a tube that extends to its associated pivotal connection 78 or 80 and moves the screw longitudinally during screw rotation to provide the length adjustment of the strut. Each pivotal connection 78 or 80 has a threaded component received by a threaded end hold of the screw to permit its rotation and axial movement.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A work station for joining metallic sheets comprising:
a floor having a mount for supporting an anvil and extending along a horizontal longitudinal X axis and a horizontal lateral Y axis perpendicular to the X axis;
a framework including posts extending upwardly along a vertical Z axis from the floor in a perpendicular relationship to the X and Y axes, and the framework including beams extending between the posts along both the X and Y axes spaced upwardly from the floor to define a workspace;
a shuttle suspended on the framework for movement along one of the X and Y axes above the workspace;
a parallel kinematic machine (PKM) including: an upper support suspended from the shuttle for movement along the other of the X and Y axes; a tripod having three struts mounted on the upper support and extending downwardly in a converging manner toward each other; and a lower support mounted by the three struts below the upper support to mount a punch operable to cooperate with the anvil to provide sheet metal deformation that joins two metallic sheets to each other;
the three struts of the PKM tripod each having an upper end connected to the upper support, a lower end pivotally connected to the lower support and an adjustable length between its upper and lower ends; and
a controller that: positions the shuttle on the framework along said one axis; positions the PKM on the shuttle along said other axis; individually adjusts the lengths of the struts to position the lower support along the Z axis and control its angular orientation to position the punch angularly;
and operates the punch to cooperate with the anvil to provide sheet metal deformation that joins two metallic sheets to each other.

2. A work station for joining metallic sheets as in claim 1 wherein each strut has a roller screw that connects the upper and lower ends of the strut and includes an elongated screw and a nut having a planet carrier and a plurality of threaded rollers rotatable on the planet carrier and meshed with the screw such that relative rotation between the screw and the nut adjusts the length of the strut, wherein the PKM includes first and second universal joint assemblies on the upper support, the first universal joint assembly pivotally mounting the upper end of a first strut on the upper support for pivoting about a first horizontal axis and about another axis perpendicular to the first horizontal axis, and the second universal joint assembly pivotally mounting the upper ends of the other two struts on the upper support for pivoting about a second horizontal axis that is parallel to the first horizontal axis of the first universal joint assembly and respectively pivotally mounting the upper ends of the other two struts about a pair of parallel axes that are each perpendicular to the second horizontal axis.

3. A work station for joining metallic sheets as in claim 2 further including a first pivotal connection that pivotally connects the lower end of the first strut to the lower support about an axis that is parallel to the first and second horizontal axes, and also including a pair of second pivotal connections that respectively pivotally connect the lower ends of the other two struts to the lower support about a pair of axes that are parallel to each other and perpendicular to the axis of the first pivotal connection.

4. A work station for joining metallic sheets as in claim 1 wherein the lower support includes a punch mounting bracket rotatable 360 degrees on the lower support and operable to support the punch for angular adjustment.

5. A work station for joining metallic sheets as in claim 5 further including an electric motor that rotatably positions the punch mounting bracket on the lower support and another electric motor that angularly positions the punch on the punch mounting bracket.

6. A work station for joining metallic sheets as in claim 1 of a sufficiently large size for receiving vehicle body components embodying the metallic sheets.

7. A method for joining metallic sheets using the work station of claim 1 to provide a clinching operation that joins the metallic sheets.

8. A method for joining metallic sheets using the work station of claim 1 to provide a self-piercing riveting operation that joins the metallic sheets.

9. A vehicle body work station for joining metallic sheets of a vehicle body comprising:
a floor having a mount for supporting an anvil and extending along a horizontal longitudinal X axis and a horizontal lateral Y axis perpendicular to the X axis;
a framework including posts extending upwardly along a vertical Z axis from the floor in a perpendicular relationship to the X and Y axes, and the framework including beams extending between the posts along both the X and Y axes spaced upwardly from the floor to define a workspace;
a shuttle suspended on the framework for movement along one of the X and Y axes above the workspace;
a parallel kinematic machine (PKM) including: an upper support suspended from the shuttle for movement along the other of the X and Y axes; a tripod having three struts mounted on the upper support and extending downwardly in a converging manner toward each other; and a lower support mounted by the three struts below the upper support to mount a punch operable to cooperate with the anvil to provide sheet metal deformation that joins two metallic sheets to each other;
the three struts of the PKM tripod each having: an upper end connected to the upper support of the PKM and a lower end pivotally connected to the lower support; and a roller screw that connects the upper and lower ends of the strut and includes an elongated screw and a nut having a planet carrier and a plurality of threaded rollers rotatable on the planet carrier and meshed with the screw such that relative rotation between the screw and the nut adjusts the length of the strut; and
the PKM including first and second universal joint assemblies on the upper support, the first universal joint assembly pivotally mounting the upper end of a first strut on the upper support for pivoting about a first horizontal axis and about another axis perpendicular to the first horizontal axis, and the second universal joint assembly pivotally mounting the upper ends of the other two struts on the upper support for pivoting about a second horizontal axis that is parallel to the first horizontal axis of the first universal joint assembly and respectively also pivotally mounting the upper ends of the other two struts about a pair of parallel axes that are each perpendicular to the second horizontal axis;
the PKM also including a first pivotal connection that pivotally connects the lower end of the first strut to the lower support about an axis that is parallel to the first and second horizontal axes, and also including a pair of second pivotal connections that respectively pivotally connect the lower ends of the other two struts to the lower support about a pair of axes that are parallel to each other and perpendicular to the axis of the first pivotal connection;
a controller that: positions the shuttle on the framework along said one axis; positions the PKM on the shuttle along the said other axis; individually operates the roller screws of the struts to position the lower support along the Z axis and control its angular orientation to position the punch angularly; and operates the punch to cooperate with the anvil to provide sheet metal deformation that joins two metallic sheets to each other by clinching or by self-piercing riveting.

10. A method for joining vehicle body metallic sheets using the work station of claim 9 to provide clinching or self-piercing riveting of the metallic sheets to each other.

11. A vehicle body work station for joining metallic sheets of a vehicle body comprising:
a floor having a mount for supporting an anvil and extending along a horizontal longitudinal X axis and a horizontal lateral Y axis perpendicular to the X axis;
a framework including posts extending upwardly along a vertical Z axis from the floor in a perpendicular relationship to the X and Y axes, and the framework including beams extending between the posts along both the X and Y axes spaced upwardly from the floor to define a workspace;
a shuttle suspended on the framework for movement along one of the X and Y axes above the workspace;
a parallel kinematic machine (PKM) including: an upper support suspended from the shuttle for movement along the other of the X and Y axes; a tripod having three struts mounted on the upper support and extending downwardly in a converging manner toward each other; and a lower support pivotally connected to the struts of the tripod;
a punch mounting bracket rotatable 360 degrees on the lower support to mount a punch operable in order to cooperate with the anvil to provide sheet metal deformation that joins two metallic sheets to each other;
an electric motor that rotatably positions the punch mounting bracket on the lower support and another electric motor that angularly positions the punch on the punch mounting bracket;
the three struts of the PKM tripod each having: an upper end connected to the upper support of the PKM and a lower end pivotally connected to the lower support; an elongated screw; and a nut including a planet carrier and a plurality of threaded rollers rotatable on the planet carrier and meshed with the screw such that relative rotation between the screw and the nut adjusts the length of the strut; and
the PKM including first and second universal joint assemblies on the upper support, the first universal joint assembly pivotally mounting the upper end of a first strut on the upper support for pivoting about a first horizontal axis and about another axis perpendicular to the first horizontal axis, and the second universal joint assembly pivotally mounting the upper ends of the other two struts on the upper support for pivoting about a second horizontal axis that is parallel to the first horizontal axis of the first universal joint assembly and respectively also pivotally mounting the upper ends of the other two struts about a pair of parallel axes that are each perpendicular to the second horizontal axis;
the PKM also including a first pivotal connection that pivotally connects the lower end of the first strut to the lower support about an axis that is parallel to the first and second horizontal axes, and also including a pair of second pivotal connections that respectively pivotally connect the lower ends of the other two struts to the lower support about a pair of axes that are parallel to each other and perpendicular to the axis of the first pivotal connection;
a controller that: positions the shuttle on the framework along said one axis; positions the PKM on the shuttle along said other axis; individually operates the roller screws of the struts to position the lower support along the Z axis and control its angular orientation to position the punch angularly; and operates the electric motors and the punch to cooperate with the anvil to provide sheet metal deformation that joins two metallic sheets to each other by clinching or by self-piercing riveting.

12. A method for joining vehicle body metallic sheets using the work station of claim 11 to provide clinching or self-piercing riveting of the metallic sheets to each other.
